(19) United States
(12) Patent Application Publication
(10) Pub. No.: US 2016/0189189 A1
(43) Pub. Date: Jun. 30, 2016

(54) CUSTOMER INFORMATION PROCESSING DEVICE AND CUSTOMER INFORMATION PROCESSING METHOD

(71) Applicant: NEC CORPORATION, Tokyo (JP)

(72) Inventors: HIROSHI TEZUKA, Tokyo (JP); MASAHARU KURODA, Tokyo (JP)

(21) Appl. No.: 14/911,507

(22) PCT Filed: Aug. 8, 2014
(86) PCT No.: PCT/JP2014/071004

§ 371 Date: Feb. 11, 2016

(30) Foreign Application Priority Data
Sep. 25, 2013 (JP) 2013-198197

(51) Int. Cl. G06Q 30/02

(52) U.S. Cl. CPC G06Q 30/0207

(57) ABSTRACT

Provided is a customer information processing device (100) including an information acquisition unit (101) that acquires a plurality of pieces of customer information indicating a plurality of customers from a customer information storage unit (105), and a display processing unit (102) that displays a list of the plurality of pieces of customer information acquired by the information acquisition unit (101) on a display unit (106). The display processing unit (102) preferentially displays a list of customer information including information on an electronic coupon of which use is declared by a customer, from the plurality of pieces of customer information acquired by the information acquisition unit (101).

### TECHNICAL FIELD

The present invention relates to a technique for managing customer information including information on an electronic coupon. Hereinafter, the wording “electronic coupon” means an electronized coupon, and indicates a broad concept that means exchange information for imparting any gain to a customer. The form of the gain imparted to a customer by the electronic coupon is not limited.

### BACKGROUND ART

Instead of point of sale (POS) register terminals of the related art, POS systems for achieving a POS register function using a general-purpose mobile terminal such as a tablet computer (PC) have been provided. The POS system is also referred to as a mobile POS system. According to the mobile POS system, there are advantages in that it is possible to reduce an introduction cost and to allow a manager on a store side to perform sales management, sales analysis, and the like regardless of a place and time in association with a cloud service.

On the other hand, various electronic coupon services for the purpose of attracting customers and promoting sales have been provided. In Patent Document 1 mentioned below, the following electronic coupon system is proposed. A portable information terminal transmits a customer ID read from a customer card and a terminal ID of the portable information terminal to a store server when a customer enters a store, and the store server associates the customer ID with the terminal ID of the portable information terminal. A store information terminal transmits the read customer ID, a terminal ID of the store information terminal, and a content ID of a displayed coupon object to the store server by holding the customer card up, and the store server provides coupon information acquired from a coupon information database on the basis of the content ID to the portable information terminal associated with the customer ID.

### RELATED DOCUMENT

### Patent Document

[Patent Document 1] Japanese Unexamined Patent Publication No. 2007-213276

### SUMMARY OF THE INVENTION

As in the proposed method mentioned above, when an electronic coupon is used in the current system, a customer displays an electronic coupon received on his or her own portable information terminal and shows the electronic coupon to a store clerk to thereby can receive a reward. However, in the current system, there is no system for evaluating the validity of the presented electronic coupon, and the provision of the electronic coupon and the reception of a reward corresponding to the electronic coupon are completely separated from and independent of each other. Accordingly, for example, when an electronic coupon is provided with limitation of a recipient, it is not possible for a store side to evaluate the validity of the presented electronic coupon. In addition, since the reward process has to be performed separately, a procedure during the use of the electronic coupon becomes complicated.

The present invention is contrived in view of such situations, and an object thereof is to provide a technique enabling the smooth use of a valid electronic coupon.

Aspects of the present invention adopt the following configurations in order to solve the above-described problems.

A first aspect relates to a customer information processing device. The customer information processing device according to the first aspect includes an information acquisition unit that acquires a plurality of pieces of customer information indicating a plurality of customers from a customer information storage unit, and a display processing unit that displays a list of the plurality of pieces of customer information acquired by the information acquisition unit on a display unit. The display processing unit preferentially displays a list of customer information including information on an electronic coupon of which use is declared by a customer, from the plurality of pieces of customer information acquired by the information acquisition unit.

A second aspect relates to a customer information processing method executed by at least one computer. The customer information processing method according to the second aspect includes acquiring a plurality of pieces of customer information indicating a plurality of customers from a customer information storage unit, and displaying the list of the acquired plurality of pieces of customer information on a display unit. The step of displaying the list of the customer information includes preferentially displaying a list of customer information including information on an electronic coupon of which use is declared by a customer, from the acquired plurality of pieces of customer information.

Meanwhile, another aspect of the present invention may be a program causing at least one computer to execute the method according to the second aspect, or may be a computer-readable recording medium having the program recorded thereon. The recording medium includes a non-transitory type medium.

According to the aspects, it is possible to provide a technique enabling the smooth use of a valid electronic coupon.

### BRIEF DESCRIPTION OF THE DRAWINGS

The above-described objects, other objects, features and advantages will become more apparent from the preferred embodiments described below, and the accompanying drawings as follows.

FIG. 1 is a schematic diagram illustrating a process configuration example of a customer information processing device according to the present embodiment.

FIG. 2 is a schematic diagram illustrating a configuration example of a mobile POS system (POS system) according to a first embodiment.

FIG. 3 is a schematic diagram illustrating a hardware configuration example of a server device.

FIG. 4 is a schematic diagram illustrating process configuration examples of a server device, a customer terminal, and a store terminal according to the first embodiment.

FIG. 5 is a flow chart illustrating an operational example of the mobile POS system (POS system) according to the first embodiment.

FIG. 6 is a diagram illustrating an example of a customer list screen.

FIG. 7 is a diagram illustrating an example of a use reception screen of an electronic coupon.

FIG. 8 is a diagram illustrating an example of a use declaration screen of an electronic coupon.

FIG. 9 is a diagram illustrating an example of a use declaration screen of an electronic coupon.

FIG. 10 is a schematic diagram illustrating a process configuration example of a store terminal according to an example.

### DESCRIPTION OF EMBODIMENTS

Hereinafter, embodiments of the invention will be described. Meanwhile, the embodiments described below are merely illustrative of the invention, and the invention is not limited to the configurations of the following embodiments.

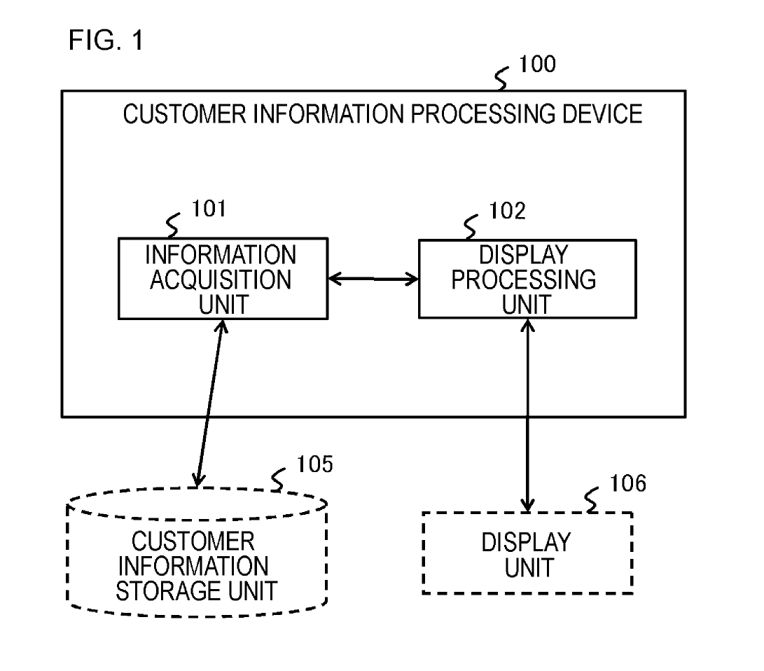

FIG. 1 is a schematic diagram illustrating a process configuration example of a customer information processing device according to the present embodiment. As illustrated in FIG. 1, a customer information processing device 100 includes an information acquisition unit 101 that acquires a plurality of pieces of customer information indicating a plurality of customers from a customer information storage unit 105, and a display processing unit 102 that displays a list of the plurality of pieces of customer information acquired by the information acquisition unit 101 on a display unit. The display processing unit 102 preferentially displays a list of pieces of customer information including information on an electronic coupon of which the use is declared by a customer, from the plurality of pieces of acquisition unit 101.

The customer information processing device 100 illustrated in FIG. 1 has the same hardware configuration as that of, for example, a server device 10 according to a detailed embodiment to be described later, and is configured such that programs are processed in the same manner as the server device 10, thereby achieving the above-mentioned processing units. In addition, a display unit 106 and the customer information storage unit 105 may be included in the customer information processing device 100, or may be included in another computer (not shown) which is communicably connected to the customer information processing device 100. The display unit 106 is a device such as a liquid crystal display (LCD) or a cathode ray tube (CRT) display which displays a screen corresponding to drawing data.

A customer information processing method according to the present embodiment is executed by at least one computer such as the customer information processing device 100, and includes the following processing steps. That is, the customer information processing method includes acquiring a plurality of pieces of customer information indicating a plurality of customers from a customer information storage unit, and displaying a list of the acquired plurality of pieces of customer information on a display unit. In the step of displaying the list, a list of pieces of customer information including information on an electronic coupon of which the use is declared by a customer, from the acquired plurality of pieces of customer information, is preferentially displayed. The display unit and the customer information storage unit may be included in at least one computer which is an execution subject of the customer information processing method, or may be included in another computer (not shown) which is communicably connected to the at least one computer. In addition, an embodiment of the present invention may relate to a program causing at least one computer to execute the above-described customer information processing method, or may relate to a computer-readable recording medium having the program recorded thereon.

In this manner, in the present embodiment, a plurality of pieces of customer information indicating a plurality of customers are acquired, and a list of pieces of customer information including information on an electronic coupon of which the use is declared by a customer is preferentially displayed when a list of the plurality of pieces of customer information is displayed. The wording “preferentially displaying of a list” as used herein means that pieces of customer information including information on an electronic coupon of which the use is declared by a customer are displayed so as to be more conspicuous than the other pieces of customer information. Specifically, the preferentially displaying of a list includes displaying target customer information at a higher position in the list, displaying the target customer information in a larger size, displaying the target customer information in a more conspicuous color than the other pieces of customer information, and the like.

The wording “customer declares the use of an electronic coupon” means that the customer is planning to use the electronic coupon. Accordingly, when a person in charge on a store side is once required to use an electronic coupon from a certain customer, there is a high possibility that a list of customer information preferentially displayed on a display unit viewed by the person in charge is information on the customer who is requiring the use of the electronic coupon. Thereby, the person in charge on the store side views the list of the customer information displayed on the display unit, and thus the person can easily find out information on a customer desiring to use an electronic coupon and immediately confirm that the customer is a valid holder of the electronic coupon on the basis of the customer information. In this case, the customer can cause the person in charge on the store side to confirm the validity of the electronic coupon only by transmitting identification information included in his or her own customer information or information on an electronic coupon of which the use is declared to the person in charge on the store side using any transmission medium (verbally, an electronic medium, or the like). The person in charge on the store side who performs the confirmation can perform a reward process (discount adjustment or the like) corresponding to an electronic coupon displayed on the display unit using, for example, information on the electronic coupon. For example, when an electronic coupon is used during adjustment, a person in charge of a cash register can immediately find information on a customer who is attempting to perform the adjustment, and smoothly perform work at the cash register. In this manner, according to the present embodiment, it is possible to enable the smooth use of a valid electronic coupon.

Hereinafter, the above-described embodiment will be described in more detail. Hereinafter, a mobile POS system will be illustrated as a detailed embodiment. Here, details of the above-described embodiment and detailed embodiments to be described later can be applied not only to the mobile POS system but also to all systems providing an electronic coupon service.

### First Embodiment

### System Configuration

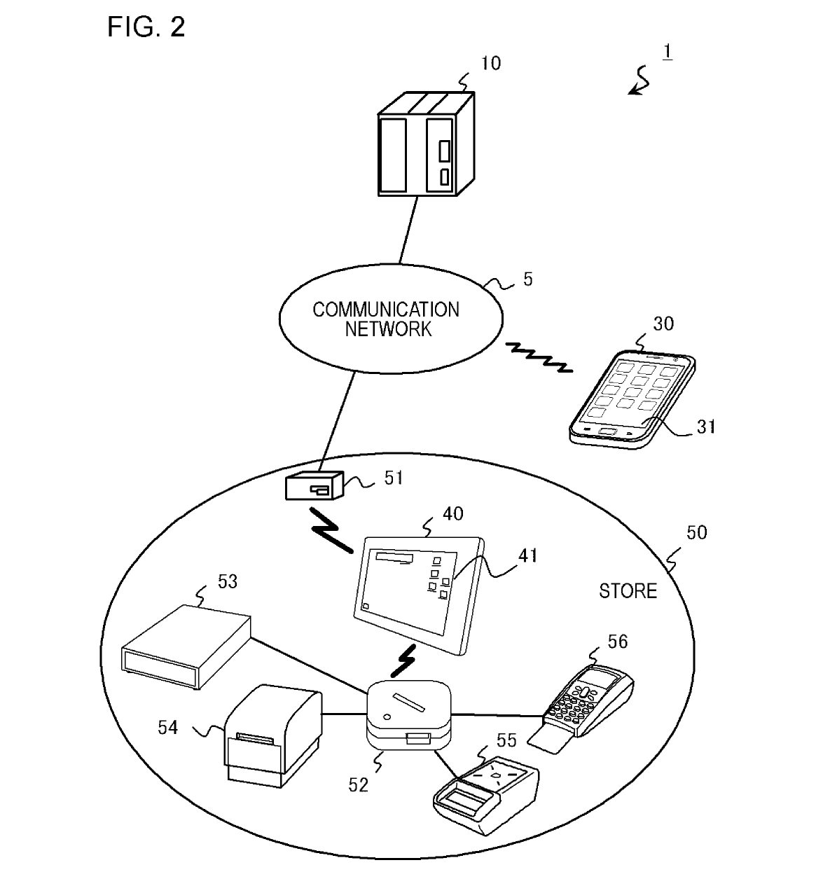

FIG. 2 is a schematic diagram illustrating a configuration example of a mobile POS system (hereinafter, simply referred to as a POS system) 1 according to a first embodiment.

The POS system 1 includes a server device 10, a portable information terminal 30, and a store side configuration 50. The POS system 1 provides an electronic coupon service to a customer who uses the portable information terminal 30, and provides a POS service to a store that uses the store side configuration 50. Hereinafter, the portable information terminal 30 is also referred to as a customer terminal 30. The server device 10 is equivalent to the customer information processing device 100 according to the above-described embodiment.

Communicable connection between the server device 10 and the store side configuration 50 and between the server device 10 and the customer terminal 30 is achieved through a communication network 5. The communication network 5 is constituted by at least one of various types of communication networks, such as a public network such as the Internet, a wide area network (WAN), a local area network (LAN), a communication carrier network, and a wireless communication network. An implementation mode of the communication network 5 is not limited.

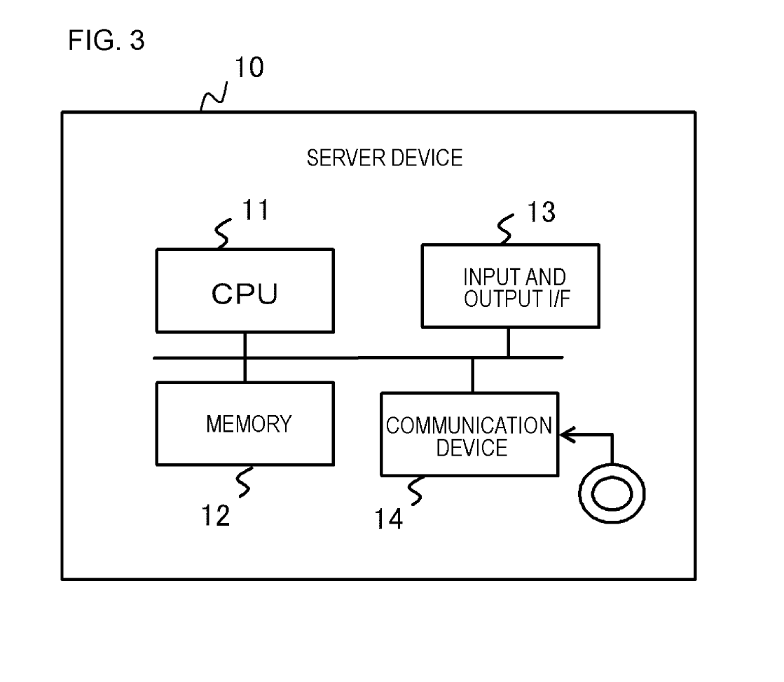

FIG. 3 is a schematic diagram illustrating a hardware configuration example of the server device 10. The server device 10 is a so-called computer, and includes a central processing unit (CPU) 11, a memory 12, an input and output interface (I/F) 13, a communication device 14, and the like which are connected to each other through, for example, a bus. The memory 12 is a random access memory (RAM), a read only memory (ROM), a hard disk, or the like. The communication device 14 communicates with another computer or device. A portable recording medium and the like may be connected to the communication device 14.

The input and output I/F 13 may be connected to a user interface device (not shown) such as a display device or an input device. The display device is a device, such as a liquid crystal display (LCD) or a cathode ray tube (CRT) display, which displays a screen corresponding to drawing data processed by the CPU 11, a graphics processing unit (GPU) (not shown), or the like. The input device is a device, such as a keyboard or a mouse, which receives an input of a user's operation. However, a display device or an input device may not be connected to the input and output I/F 13. A hardware configuration of the server device 10 is not limited.

The customer terminal 30 is a so-called portable computer such as a personal computer (PC), a mobile phone, a smartphone, or a tablet terminal. For example, the customer terminal 30 has a hardware configuration as illustrated in FIGS. 2 and 3. According to the example of FIG. 2, the customer terminal 30 includes a touch panel unit 31 including a display unit and a touch sensor, as a user interface device. The display unit includes a monitor such as a liquid crystal display (LCD) or a cathode ray tube (CRT) display, and performs a display process. The touch sensor receives an input of a user's operation by sensing a touch from the outside or a proximate state. However, the hardware configuration of the customer terminal 30 is not limited.

The store side configuration 50 includes a communication relay device 51, a store terminal 40, a stand 52, a cash drawer 53, a receipt printer 54, an electronic money reader writer 55, a credit card reader writer 56, and the like. The stand 52 is a device for communicably connecting the store terminal 40 to another device (cash drawer 53, receipt printer 54, electronic money reader writer 55, credit card reader writer 56, or the like). The store terminal 40 and the stand 52 are connected to each other through, for example, short-distance wireless communication such as Bluetooth (registered trademark) or infrared communication, wireless communication such as a wireless LAN, or wired communication such as a universal serial bus (USB). The stand 52 and the other devices are connected to each other through various types of communication lines or in a wireless manner. The communication relay device 51 connects the store terminal 40 to a communication network 5, and enables communication between the store terminal 40 and the server device 10. Meanwhile, a communication mode between nodes is not limited. The store terminal 40 may be connected to the communication network 5 using a 3G network or the like through a wireless base station without going through the communication relay device 51. The cash drawer 53, the receipt printer 54, the electronic money reader writer 55, and the credit card reader writer 56 are equivalent to partial devices included in a general POS cash register device.

The store terminal 40 is the same portable computer as the customer terminal 30. The store terminal 40 may be a stationary general-purpose computer which is the same as the server device 10. For example, the store terminal 40 has a hardware configuration as illustrated in FIGS. 2 and 3. According to the example of FIG. 2, the store terminal 40 includes a touch panel unit 41 including a display unit and a touch sensor, as a user interface device. However, the hardware configuration of the store terminal 40 is not limited.

[Process Configuration]

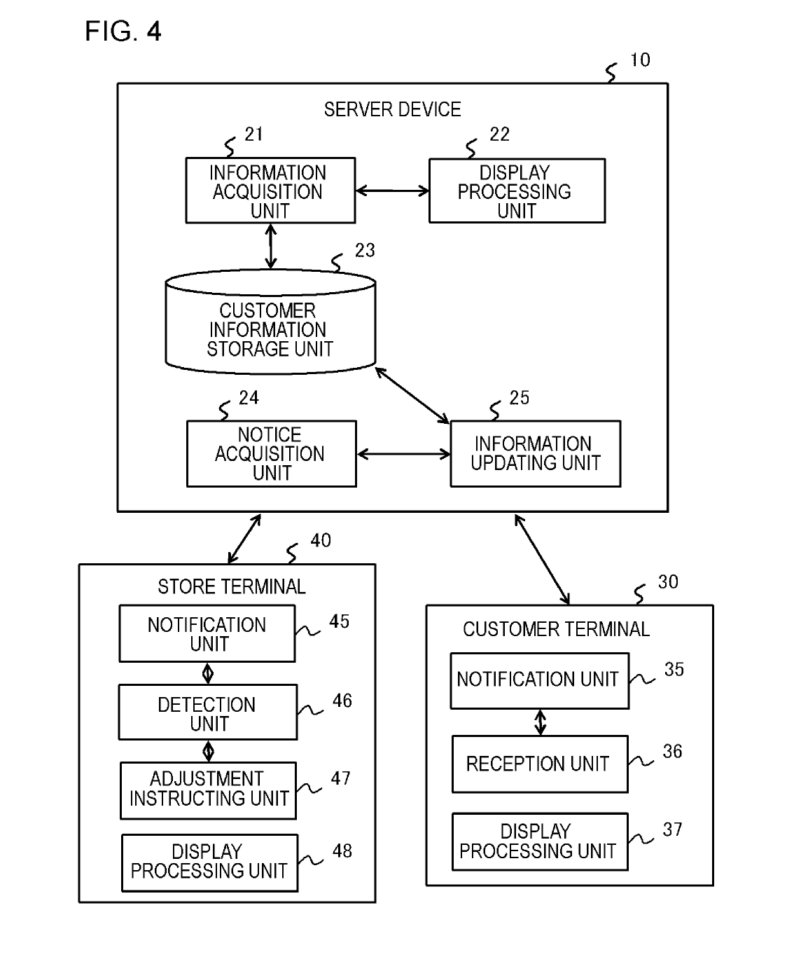

FIG. 4 is a schematic diagram illustrating process configuration examples of the server device 10, the customer terminal 30, and the store terminal 40 according to the first embodiment.

<<Server Device>>

The server device 10 according to the first embodiment includes an information acquisition unit 21, a display processing unit 22, a customer information storage unit 23, a notice acquisition unit 24, an information updating unit 25, and the like. These processing units are achieved, for example, by causing the CPU 11 to execute a program stored in the memory 12. In addition, the program may be installed through the input and output I/F 13 or the communication device 14 from a portable recording medium, such as a compact disc (CD) or a memory card, or another computer on a network, or may be stored in the memory 12.

The information acquisition unit 21 is equivalent to the above-mentioned information acquisition unit 101. The information acquisition unit 21 acquires a plurality of pieces of customer information indicating a plurality of customers from the customer information storage unit 23. For example, when the customer information storage unit 23 stores customer information for each store, the information acquisition unit 21 designates a target store to thereby acquire a plurality of pieces of customer information on the target store. For example, identification information of a store is used to designate the target store.

In addition, when the customer information stored in the customer information storage unit 23 includes store visit condition information with respect to each store, the information acquisition unit 21 may acquire a plurality of pieces of customer information indicating a plurality of customers who are at least one of a type of customer predicted to be currently visiting a target store and a type of customer planning to visit the target store. In this case, the information acquisition unit 21 may acquire a plurality of pieces of customer information indicating the at least one type of customer and a customer who visited the target store in the past. A method of acquiring store visit condition information with respect to each store will be described later.

The customer information storage unit 23 stores customer information for each customer. The customer information includes identification information of a customer. Further, when a customer possesses an electronic coupon, the customer information includes information on the electronic coupon. Further, the information on the electronic coupon includes information indicating a use condition. For example, when a customer declares the use of an electronic coupon, information on the electronic coupon is set to a use declaration state. In addition, when the electronic coupon is used, information on the electronic coupon may be set to a used state.

In addition, as described above, the customer information may also include store visit condition information with respect to each store. The store visit condition information indicates a store visit condition such as a current store visit, a past experience of having visiting a store, or a plan to visit a store, and identification information of a target store. The store visit condition information is acquired by a processing unit not shown in FIG. 4, and is reflected on the customer information stored in the customer information storage unit 23. A condition in which a customer is currently visiting a target store may be determined from positional information obtained from a global positioning system (GPS) or a wireless base station, and store information obtained from a check-in function of a social network service (SNS), Shopkick (registered trademark), or the like. For example, when the positional information indicates being within 100 meters (m) from a target store, it can be estimated that the customer is currently visiting the target store. In addition, the plan to visit a store may be determined from a customer's use declaration of an electronic coupon, schedule information of a customer, or the like. The past experience of having visit a store may be determined from use results of an electronic coupon, results that store visit condition information had been a state of “a current store visit” or a “plan to visit a store”, or the like. The present embodiment does not limit a method of acquiring a store visit condition for each customer.

The display processing unit 22 acquires data required to cause the customer terminal 30 and the store terminal 40 to display various types of screens on the basis of the customer information acquired from the customer information storage unit 23, and transmits the data to the customer terminal 30 and the store terminal 40. The form of the data acquired by the display processing unit 22 is not limited. For example, when a WEB system is used as a user interface, the data is created as drawing data such as data in the form of an hypertext markup language (HTML) or data of JAVA (registered trademark). In addition, the data may be partial information extracted from the customer information as an object to be displayed.

The display processing unit 22 is equivalent to the display processing unit 102 mentioned above. The display processing unit 22 acquires data for displaying a list of the plurality of pieces of customer information acquired by the information acquisition unit 21. At this time, the display processing unit 22 acquires data required to preferentially display a list of customer information including information on an electronic coupon set to a use declaration state from the plurality of pieces of customer information acquired by the information acquisition unit 21. The preferentially displaying of a list is as described above. Further, the display processing unit 22 excludes customer information including information on an electronic coupon set to a used state, from a list of objects to be preferentially displayed.

The display processing unit 22 transmits the data acquired as described above to the store terminal 40 through the communication device 14. Thereby, in the store terminal 40, a list of customer information is displayed on the basis of the data. Hereinafter, a screen on which a list is displayed in the store terminal 40 may also be referred to as a customer list screen.

The display processing unit 22 may also transmit screen data for causing a user of the store terminal 40 to perform a use reception operation to the store terminal 40. In addition, the display processing unit 22 may also transmit data for displaying a list of information on an electronic coupon possessed by a customer who is a user of the customer terminal 30 in the customer terminal 30, to the customer terminal 30. Further, the display processing unit 22 may also transmit screen data for causing the customer to perform a use declaration operation of the electronic coupon to the customer terminal 30. Screens displayed on the customer terminal 30 and the store terminal 40 will be illustrated in the paragraph of an example.

The notice acquisition unit 24 receives a notice of a customer's use declaration of an electronic coupon from the customer terminal 30. Further, the notice acquisition unit 24 receives a notice of the use reception of an electronic coupon from the store terminal 40. Both the notices are communication data indicating that a use declaration operation of an electronic coupon is performed in the customer terminal 30, and communication data indicating that a use reception operation of an electronic coupon is performed in the store terminal 40.

The information updating unit 25 updates information on an electronic coupon in the customer information stored in the customer information storage unit 23. Specifically, the information updating unit 25 sets information on an electronic coupon included in the customer information of a customer which is stored in the customer information storage unit 23, the customer being the source of the notice, to a use declaration state on the basis of the use declaration notice which is acquired by the notice acquisition unit 24.

In addition, the information updating unit 25 sets the information on the electronic coupon stored in the customer information storage unit 23 to a used state on the basis of the use reception notice which is acquired by the notice acquisition unit 24. The setting of the used state may be achieved by setting a used flag included in information on a target electronic coupon, or may be achieved by deleting information on a target electronic coupon from the customer information. The information updating unit 25 can specify information on an electronic coupon set to a used state from the customer information storage unit 23 using identification information of an electronic coupon which is included in the use reception notice.

<<Portable Information Terminal (Customer Terminal)>>

The customer terminal 30 according to the first embodiment includes a notification unit 35, a reception unit 36, a display processing unit 37, and the like. These processing units are achieved, for example, by causing the CPU 11 to execute a program stored in the memory 12. In addition, the program may be installed through the input and output I/F 13 or the communication device 14 from a portable recording medium, such as a compact disc (CD) or a memory card, or another computer on a network, or may be stored in the memory 12.

The display processing unit 37 displays a list of information on an electronic coupon on a display unit (display portion) of the touch panel unit 31 on the basis of data transmitted from the server device 10. As described above, the form of the data transmitted from the server device is not limited. For example, when HTML data is transmitted from the server device 10 as drawing data, the display processing unit 37 is equivalent to a web browser. At this time, a user (customer) of the customer terminal 30 is identified in the server device 10, and the customer terminal 30 acquires information on an electronic coupon possessed by the identified user. The identification of the user in the server device 10 can be achieved by a well-known method such as a user login.

The reception unit 36 receives a use declaration operation of user for an electronic coupon displayed on the display unit. For example, the display processing unit 37 displays a button for use declaration together with information on a target electronic coupon on the display unit, and the reception unit 36 receives the use declaration operation for the target electronic coupon from a relationship between an operation position detected by the touch sensor of the touch panel unit 31 and a display position of the button. However, the present embodiment does not limit a user's use declaration operation for an electronic coupon.

The notification unit 35 notifies the server device 10 of the use declaration of the electronic coupon in accordance with the use declaration operation received by the reception unit 36. The notice includes identification information of a target electronic coupon.

<<Store Terminal>>

The store terminal 40 according to the first embodiment includes a notification unit 45, a detection unit 46, an adjustment instructing unit 47, a display processing unit 48, and the like. These processing units are achieved, for example, by causing the CPU 11 to execute a program stored in the memory 12. In addition, the program may be installed through the input and output I/F 13 or the communication device 14 from a portable recording medium, such as a compact disc (CD) or a memory card, or another computer on a network, or may be stored in the memory 12.

The display processing unit 48 displays a customer list screen on the display unit (display portion) of the touch panel unit 41 on the basis of data transmitted from the server device 10. As described above, the form of the data transmitted from the server device 10 for the customer list screen is not limited. For example, when HTML data is transmitted from the server device 10 as drawing data, the display processing unit 48 is equivalent to a web browser. In addition, when the customer information storage unit 23 of the server device 10 stores customer information for each store, a store of a user of the store terminal 40 is identified in the server device 10, and the store terminal 40 acquires customer information of the identified store.

The detection unit 46 detects a use reception operation for an electronic coupon of one customer selected from a list of a plurality of pieces of customer information displayed on the display unit. For example, the display processing unit 48 displays a button for use reception on the display unit, and the detection unit 46 detects a use reception operation from a relationship between an operation position detected by the touch sensor of the touch panel unit 31 and a display position of the button. At this time, the detection unit 46 also specifies customer information which is selected by a user from a list of the plurality of pieces of customer information displayed on the display unit. However, the present embodiment does not limit a use reception operation for an electronic coupon. Here, the wording “use reception of an electronic coupon” means that a store side allows a customer to use an electronic coupon. Accordingly, when use reception is performed, the store side performs a process of giving the customer a reward corresponding to the electronic coupon.

The notification unit 45 notifies the server device 10 of the use reception of an electronic coupon in accordance with the use reception operation detected by the detection unit 46. The notice includes identification information of a target electronic coupon.

The adjustment instructing unit 47 instructs the execution of an adjustment process to which a discount corresponding to an electronic coupon is applied, using information on the electronic coupon in accordance with the use reception operation detected by the detection unit 46. An instruction destination of the adjustment instructing unit 47 is a processing unit (not shown) providing a well-known POS register function, and the processing unit is achieved by the store terminal 40, the server device 10, or another computer. For example, discount information corresponding to the electronic coupon is added to the instruction.

### Operation Example

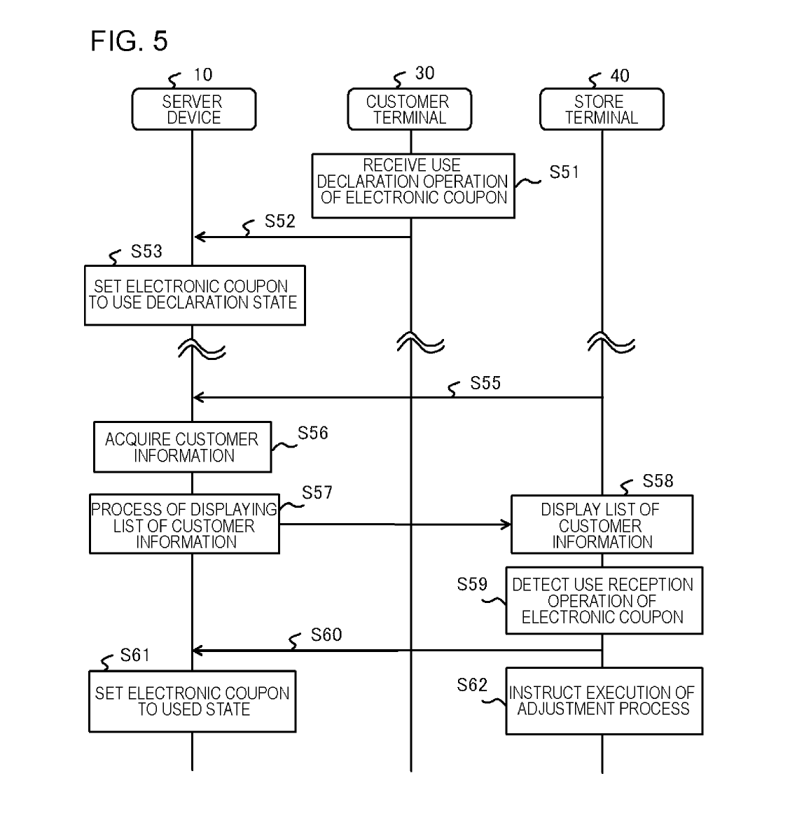

Hereinafter, a customer information processing method according to the first embodiment will be described with reference to FIG. 5. FIG. 5 is a flow chart illustrating an operational example of the POS system 1 according to the first embodiment. Hereinafter, a description will be given by setting the server device 10, the customer terminal 30, or the store terminal 40 as an execution subject of each method, but the execution subject may be at least one computer constituting the POS system 1.

The server device 10 stores customer information of a target store corresponding to the store terminal 40 in the customer information storage unit 23. Each piece of customer information includes identification information of a customer and information on an electronic coupon possessed by the customer. When the customer possesses a plurality of electronic coupons, the customer information on the customer includes information of the plurality of electronic coupons. At this point, the server device 10 already acquires information capable of identifying a user (customer) of the customer terminal 30 and information capable of identifying a target store corresponding to the store terminal 40.

The customer terminal 30 displays a list of information on an electronic coupon possessed by the user (customer) of the customer terminal 30 on the basis of data obtained from the server device 10. The user selects a desired electronic coupon from the list of the electronic coupon information by operating the customer terminal 30, and performs a use declaration operation for the electronic coupon. The customer terminal 30 receives the use declaration operation (S51). The customer terminal 30 notifies the server device that the use declaration of the electronic coupon is performed (S52).

The server device 10 specifies customer information on the user (customer) of the customer terminal 30 and information on the electronic coupon of which the use is declared, from the customer information storage unit 23, on the basis of the notice (S52), and sets the information on the electronic coupon to a use declaration state (S53). The server device 10 can specify information on a target electronic coupon using identification information of the electronic coupon included in the notice in (S52).

This is an operation of the POS system 1, the operation related to the use declaration of an electronic coupon by the user of the customer terminal 30. Such an operation is executed at any timing asynchronously with the subsequent operations.

The store terminal 40 requests customer information from the server device 10 (S55).

The server device 10 acquires customer information of a target store which is a request source from the customer information storage unit 25 in response to the request (S56). However, the server device 10 may voluntarily specify the customer information of the target store. For example, the server device 10 can detect customer information in which a use declaration state of an electronic coupon is updated, and can specify a store having the customer information as a target store. In this case, (S55) is not necessary.

The server device 10 displays a list of the customer information acquired in (S56) on the store terminal 40 so that customer information including the information on the electronic coupon set to a use declaration state is displayed in preference to the other pieces of customer information (S57). At this time, the server device 10 may transmit drawing data (screen data) for displaying a list to the store terminal 40, or may transmit the customer information itself to the store terminal 40.

The store terminal 40 displays a customer list screen by the process in (S57) of the server device 10 (S58). In the customer list screen, customer information including information on an electronic coupon set to a use declaration state is displayed in preference to the other pieces of customer information. At this time, it is assumed that an electronic coupon of which the use is declared by a user of the customer terminal 30 is an electronic coupon of a target store in which the store terminal 40 is used. In this case, in the customer list screen displayed on the store terminal 40, customer information on the user of the customer terminal is preferentially displayed.

The user of the customer terminal 30 goes to the target store and requests the use of the electronic coupon from a person in charge of the target store. A user (person in charge of the target store) of the store terminal 40 finds out customer information on the user of the customer terminal from the customer list screen displayed in (S58) in response to the request. At this time, as described above, the store terminal 40 preferentially displays the customer information on the user of the customer terminal 30, and thus the person in charge can easily find the customer information on the customer.

The person in charge performs a use reception operation for an electronic coupon included in the customer information on the customer. Thereby, the store terminal 40 detects the use reception operation for the electronic coupon (S59). The store terminal 40 notifies the server device 10 that the use reception for the electronic coupon is performed (S60).

The server device 10 specifies information on a target electronic coupon of the customer terminal 30 from the customer information storage unit 23 on the basis of the notice (S60), and sets the information on the electronic coupon to a used state (S61). The server device 10 can specify information on a target electronic coupon using identification information of the electronic coupon included in the notice in (S60). Thereby, the server device 10 excludes customer information in which information on an electronic coupon is set to a used state, from a list of objects to be preferentially displayed, when subsequently performing (S57).

On the other hand, when the store terminal 40 detects the use reception operation for the electronic coupon (S59), the store terminal instructs the execution of an adjustment process to which a discount corresponding to the electronic coupon is applied, using the information on the electronic coupon (S62). The store terminal 40 performs the instruction on a processing unit, achieved by the store terminal 40 itself or another computer such as the server device 10, which provides a well-known POS register function. Thereby, a discount imparted to an electronic coupon of which the use is received is applied to a charge for the user of the customer terminal 30.

### Operations and Effects of First Embodiment

As described above, in the first embodiment, in the customer terminal 30, a user's use declaration operation for an electronic coupon is received, and the server device 10 is notified of the use declaration of the electronic coupon in accordance with the use declaration operation. In the server device 10, information on an electronic coupon included in customer information on a customer who is a notice source is set to a use declaration state on the basis of the notice. Subsequently, the customer information including the information on the electronic coupon set to a use declaration state in this manner is displayed in preference to the other pieces of customer information in a list displayed on the store terminal 40.

Therefore, according to the first embodiment, a customer can perform use declaration on an electronic coupon desired to be used from now on by using the customer terminal 30. The use declaration may be performed after visiting a target store, or may be performed on the way to the target store. On the other hand, a person in charge of the target store can easily find information on the customer with reference to a customer list screen of the store terminal 40 when the customer visits the store and requests the actual use of the electronic coupon, and can immediately confirm that the customer is a valid holder of the electronic coupon on the basis of the customer information. The confirmation can be easily achieved by comparing the information on the customer displayed on the customer list screen with information transmitted from the customer requesting the use of the electronic coupon verbally or using the screen of the customer terminal 30.

In this manner, a use declaration state for an electronic coupon is provided, and the state of the electronic coupon is reflected on a list of customer information displayed on the store terminal 40. Therefore, according to the first embodiment, it is possible to enable the smooth use of a valid electronic coupon and to give advantages to both a customer and a store. The customer can remember to use the electronic coupon, to reliably obtain a reward by the electronic coupon, and to simply use the electronic coupon only by using the customer terminal 30. The store can confirm the validity of the electronic coupon by simply operating and confirming the store terminal 40 and obtain a customer attracting effect and a sales promoting effect by the promotion of use of the electronic coupon. Further, the store can predict that a user as a holder of the electronic coupon set to a use declaration state is currently visiting the store or plans to visit the store.

Further, in the first embodiment, it is possible to perform a use reception operation of an electronic coupon in the store terminal 40 by a person in charge of a store. The server device 10 is notified of use reception from the store terminal 40, and information on the electronic coupon is set to a used state on the basis of the notice. Subsequently, customer information including the information on the electronic coupon set to a used state in this manner is excluded from a list of objects to be preferentially displayed in a list displayed on the store terminal 40. In this manner, according to the first embodiment, it is possible to manage the use state of the electronic coupon. Further, the store terminal 40 can instruct the execution of an adjustment process to which a discount corresponding to the electronic coupon is applied, using information on the electronic coupon subjected to the use reception operation, and thus can smoothly perform a reward process corresponding to the electronic coupon.

The above-described contents will be described more specifically with reference to the following example. However, the present invention is not limited by the following example. In the following example, a specific screen displayed on the customer terminal 30 and the store terminal 40 will be illustrated.

### Example

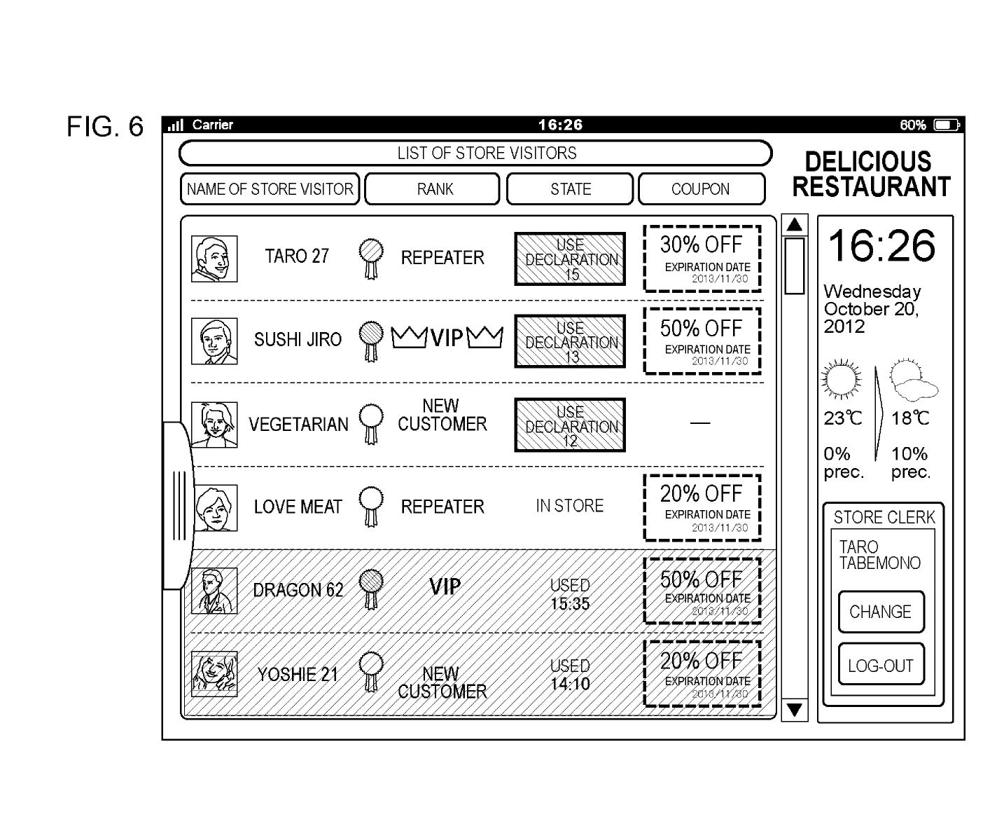

FIG. 6 is a diagram illustrating an example of a customer list screen. The store terminal 40 displays a customer list screen as illustrated in FIG. 6 on the basis of data from the server device 10. Customer information for each customer is displayed in each row. In the example of FIG. 6, a store visitor name (customer name), a rank, a state, and coupon information are displayed as the customer information. In this example, the store visitor name may be used as identification information of the customer, or a customer ID included in the customer information may be used as identification information of the customer separately from the store visitor name. The rank indicates ranking of the customer in a target store, and the state indicates use conditions (use declaration state and used state) of the electronic coupon and store visit conditions (being in a store, and the like) of the customer. The coupon information indicates reward details and an expiration date of the electronic coupon. However, the customer information is not limited to the information.

In the example of FIG. 6, pieces of customer information (pieces of customer information including Taro 27, Sushi Jiro, and vegetarian) which include an electronic coupon set to a use declaration state are displayed at an upper position of a list. Thereby, a user of the store terminal 40 can easily find out the customer information of the customer who requests the use of the electronic coupon by confirming the upper position of the list. In this case, the user of the store terminal 40 can specify the requested electronic coupon by causing the customer requesting the use of the electronic coupon to say a store visitor name (customer name), and to confirm the validity of the electronic coupon.

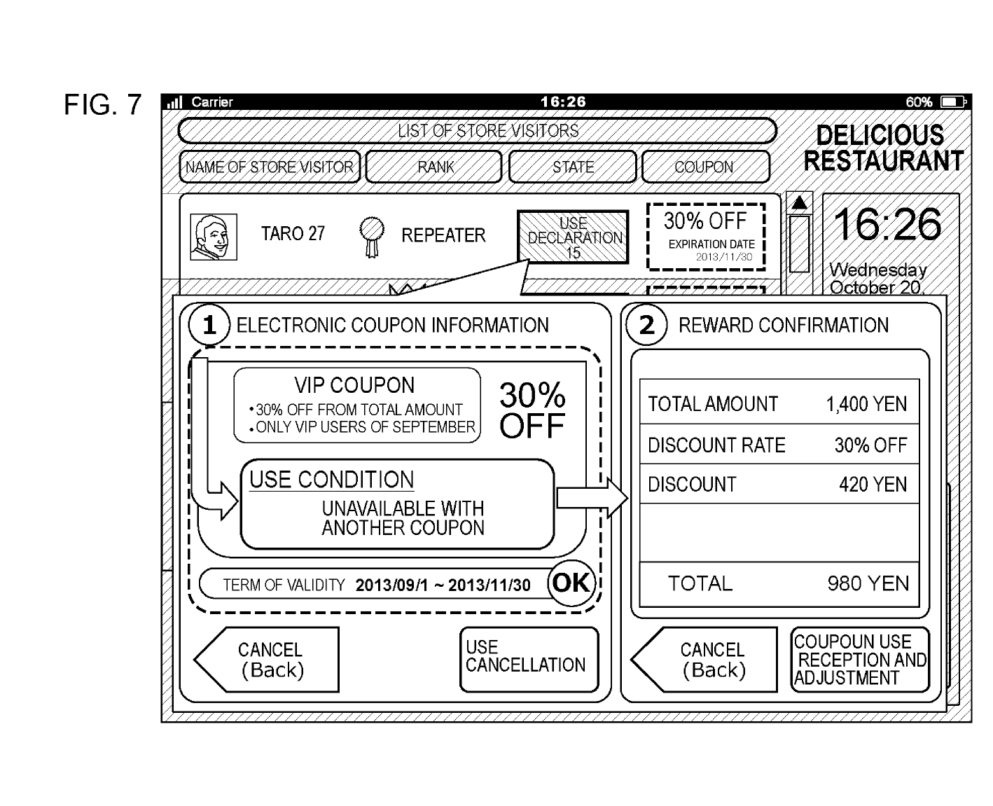

FIG. 7 is a diagram illustrating an example of a use reception screen of an electronic coupon. When certain customer information is selected in a customer list screen, the store terminal 40 displays a screen illustrated in the example of FIG. 7 using information on an electronic coupon included in the customer information. Details of the electronic coupon such as reward details, use conditions, and the term of validity are displayed in a display region for the electronic coupon information. Adjustment information having a reward corresponding to the electronic coupon applied thereto is displayed in a display region for reward confirmation. For example, the store terminal 40 can acquire adjustment information to which a reward applies from a processing unit for achieving a POS register function. In the example of FIG. 7, the store terminal 40 detects the pressing-down of a “coupon use reception and adjustment” button in the display region for reward confirmation, as a use reception operation of the electronic coupon. By the detection, the store terminal 40 notifies the server device 10 of the use reception of the electronic coupon and instructs the processing unit to perform an adjustment process. According to this example, the use reception of the electronic coupon and the adjustment process including the application of a reward corresponding to the electronic coupon are performed on the store terminal 40.

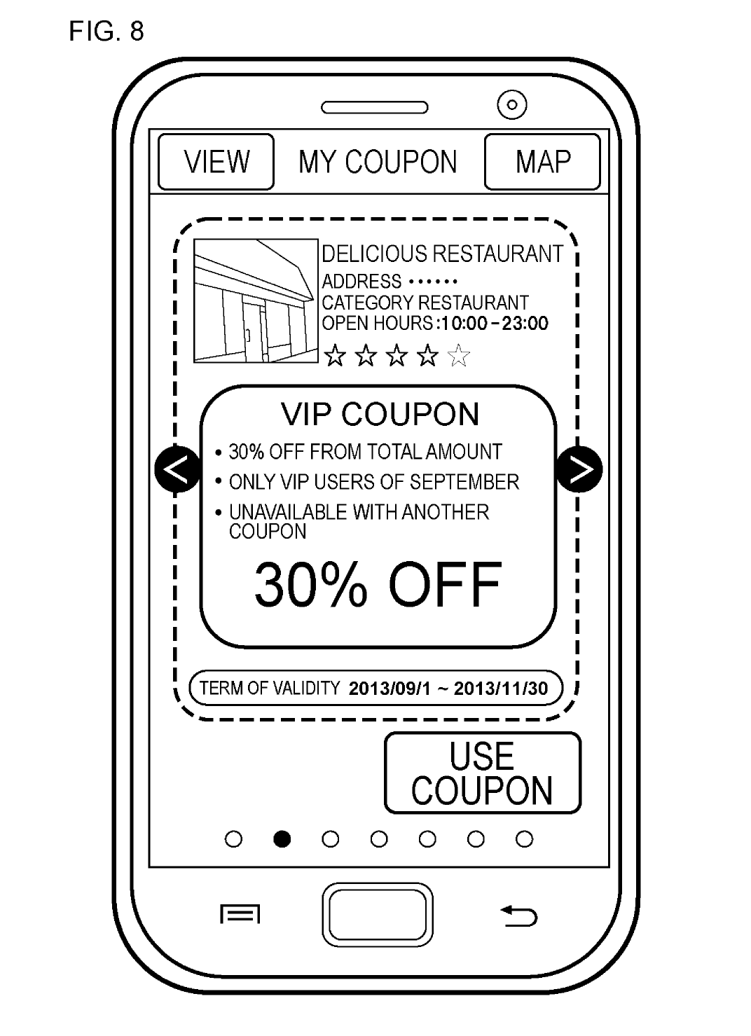

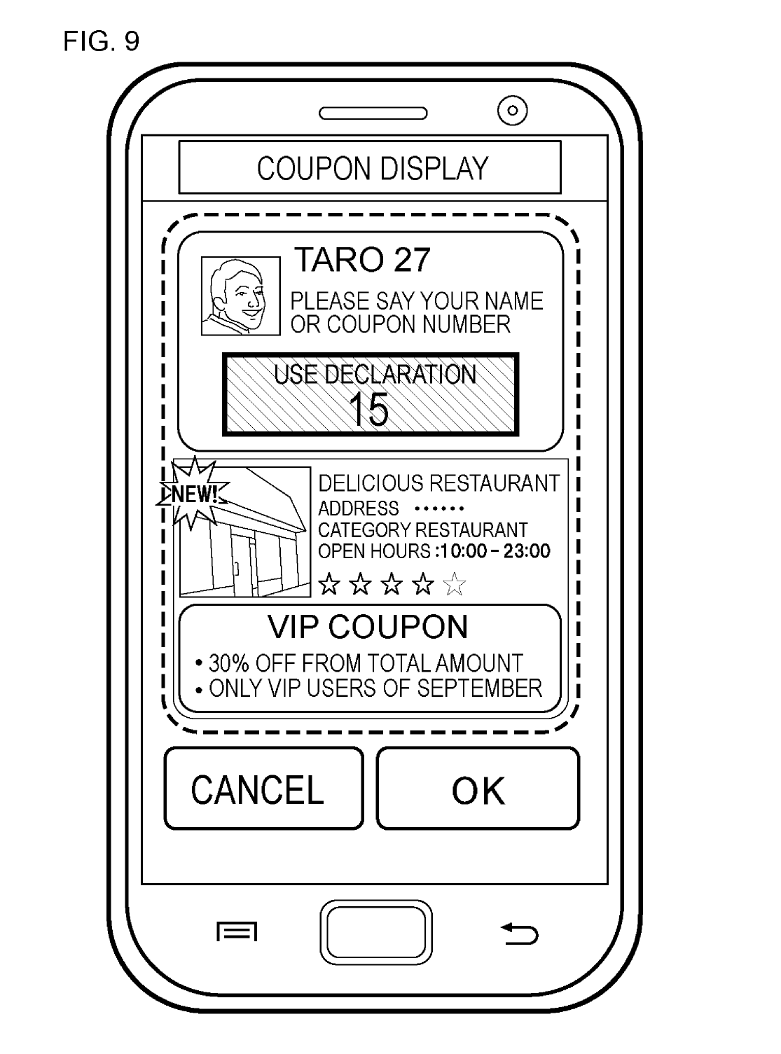

FIGS. 8 and 9 are diagrams illustrating examples of a use declaration screen of an electronic coupon. When one electronic coupon is selected from a list of pieces of electronic coupon information displayed, the customer terminal 30 displays a screen illustrated in FIG. 8 using information on the selected electronic coupon. In the example of FIG. 8, store information (store name; delicious restaurant or the like) capable of using the electronic coupon, and details of the electronic coupon (reward details, use conditions, the term of validity, and the like) are displayed. When the pressing of a “use the coupon” button is detected, the customer terminal 30 displays a screen illustrated in FIG. 9. A user of the customer terminal 30 fixes the use declaration of the electronic coupon by pressing down an “OK” button in the screen of FIG. 9. That is, in this example, the customer terminal 30 detects the pressing-down of the “OK” button in the screen of FIG. 9 to thereby receive a use declaration operation for the electronic coupon. The customer terminal 30 notifies the server device 10 of the use declaration of the electronic coupon in accordance with the reception of the use declaration operation. In the present example, the customer terminal 30 receives a use declaration operation by two operations in two screens as in the examples of FIGS. 8 and 9, but may receive a use declaration operation by the pressing-down of the “use the coupon” button in the screen of FIG. 8.

In addition, as illustrated in FIGS. 6 and 7, an electronic coupon set to a use declaration state is given a number. Specifically, in FIG. 6, numbers of “15”, “13” and “12” are displayed under the display of “use declaration” in a state column. Each of the numbers is identification information of an electronic coupon set to a use declaration state.

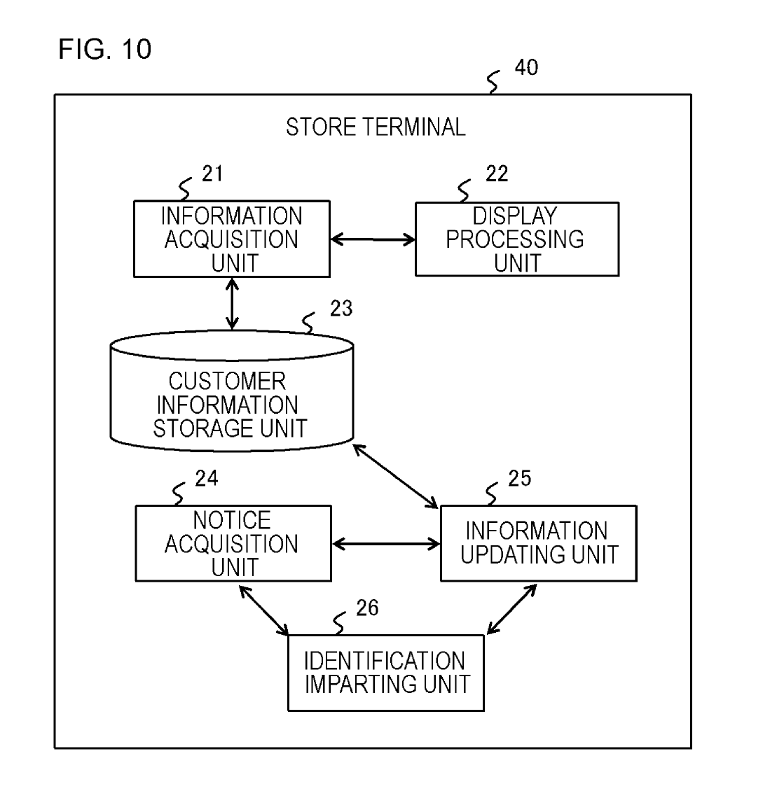

FIG. 10 is a schematic diagram illustrating a process configuration example of the store terminal 40 according to the example. In this case, the store terminal 40 further includes an identification imparting unit 26 in addition to the configuration of each embodiment described above. The identification imparting unit 26 is achieved in the same manner as other processing units. The identification imparting unit 26 imparts new identification information to an electronic coupon of which the use is newly declared, the identification information being different from that of another electronic coupon of which the use is already declared. The information updating unit 25 sets the new identification information in information of a target electronic coupon which is stored in the customer information storage unit 23.

According to this example, a person in charge on a store side can easily confirm the validity of an electronic coupon by comparing identification information obtained from a customer requesting the use of the electronic coupon with identification information displayed on a customer list screen of the store terminal 40 to be referred to. In addition, the customer does not need to tell his or her name (customer name or the like), and can use the electronic coupon only by presenting identification information of the electronic coupon of which the use is declared to the person in charge on the store side.

### Modification Example

In the first embodiment described above, an example in which the server device 10 is present outside the store side configuration 50 is illustrated, but the server device 10 may be achieved as one device within the store side configuration 50. Similarly, the customer terminal 30 may also be achieved as one device within the store side configuration 50. In this case, a customer borrows the customer terminal 30 from the store and uses the customer terminal 30. In addition, the customer terminal 30 may be connected to the communication network 5 through the communication relay device 51 within the store side configuration 50.

In the first embodiment described above, customer information including information on an electronic coupon set to a use declaration state is displayed in preference to the other pieces of customer information in a list displayed on the store terminal 40, and customer information including information regarding an electronic coupon set to a used state is excluded from an object to be preferentially displayed in the list displayed on the store terminal 40. However, the electronic coupon set to a use declaration state may not be used. Consequently, the server device 10 may exclude customer information including information on an electronic coupon from an object to be preferentially displayed by canceling a use declaration state indicated by the information on the electronic coupon.

In this case, the information updating unit 25 can cancel the use declaration state in accordance with a notice of a user's cancelling operation of use declaration using the customer terminal 30. In addition, the information updating unit 25 can measure the duration of the use declaration state, and can cancel the use declaration state when the duration exceeds a predetermined period of time. In addition, the information updating unit 25 may cancel the use declaration state from positional information of the customer. In addition, the information on the electronic coupon which is stored in the customer information storage unit 23 is not updated, and the display processing unit 22 may exclude the customer information including the information on the electronic coupon from an object to be preferentially displayed. In this case, even when the information on the electronic coupon is set to a use declaration state, the display processing unit 22 may exclude the customer information including the information on the electronic coupon from an object to be preferentially displayed when a store visit condition or position of the customer which is included in the customer information indicates being away from the store.

A portion or the entirety of the details described above may be specified as the following addition. However, the details described above are not limited to the following description.

### APPENDIX 1

A customer information processing device including:

an information acquisition unit that acquires a plurality of pieces of customer information indicating a plurality of customers from a customer information storage unit; and

a display processing unit that displays a list of the plurality of pieces of customer information acquired by the information acquisition unit on a display unit,

wherein the display processing unit preferentially displays a list of customer information including information on an electronic coupon of which use is declared by a customer, from the plurality of pieces of customer information acquired by the information acquisition unit.

### APPENDIX 2

The customer information processing device according to Appendix 1, further including:

a notice acquisition unit that receives a notice of a customer's use declaration of an electronic coupon; and

an information updating unit that sets the information on the electronic coupon included in the customer information of the customer which is stored in the customer information storage unit, the customer being the source of the notice, to a use declaration state on the basis of the notice of the use declaration.

### APPENDIX 3

The customer information processing device according to Appendix 2, further including:

an identification imparting unit that imparts new identification information to an electronic coupon of which use is newly declared, the identification information being different from that of another electronic coupon of which use is already declared,

wherein the information updating unit sets the new identification information in the information on the electronic coupon.

### APPENDIX 4

The customer information processing device according to Appendix 2 or 3,

wherein the notice acquisition unit further receives a notice of use reception of an electronic coupon,

wherein the information updating unit sets the information on the electronic coupon, stored in the customer information storage unit, to a used state on the basis of the notice of the use reception, and

wherein the display processing unit excludes customer information having the information on the electronic coupon set to a used state from a list of objects to be preferentially displayed.

### APPENDIX 5

The customer information processing device according to any one of Appendixes 2 to 4,

wherein the information updating unit cancels the use declaration state indicated by the information on the electronic coupon which is stored in the customer information storage unit, in accordance with the duration of the use declaration state of the electronic coupon, and

wherein the display processing unit excludes customer information in which the use declaration state indicated by the information on the electronic coupon is canceled, from a list of objects to be preferentially displayed.

### APPENDIX 6

The customer information processing device according to any one of Appendixes 1 to 5,

wherein the information acquisition unit acquires the plurality of pieces of customer information indicating a plurality of customers who are at least one of a type of customer predicted to be currently visiting a target store and a type of customer planning to visit the target store, or the plurality of pieces of customer information indicating the at least one type of customer and a customer who visited the target store in the past.

### APPENDIX 7

A portable information terminal capable of communicating with the customer information processing device according to any one of Appendixes 1 to 6, the portable information terminal including:

a display unit that displays information on an electronic coupon;

a reception unit that receives a use declaration operation for the electronic coupon displayed on the display unit; and

a notification unit that notifies the customer information processing device of use declaration of the electronic coupon in accordance with the use declaration operation received by the reception unit.

### APPENDIX 8

A store side processing terminal capable of communicating with the customer information processing device according to any one of Appendixes 1 to 6, the store side processing terminal including:

the display unit;

a detection unit that detects a use reception operation for an electronic coupon of one customer selected from a list of a plurality of pieces of customer information displayed on the display unit;

a notification unit that notifies the customer information processing device of use reception of the electronic coupon in accordance with the use reception operation detected by the detection unit; and

an adjustment instructing unit that instructs execution of an adjustment process to which a discount corresponding to the electronic coupon is applied, using the information on the electronic coupon in accordance with the use reception operation detected by the detection unit.

### APPENDIX 9

A customer information processing method executed by at least one computer, the customer information processing method including:

acquiring a plurality of pieces of customer information indicating a plurality of customers from a customer information storage unit; and

displaying a list of the acquired plurality of pieces of customer information on a display unit,

wherein the displaying of the list of the customer information includes preferentially displaying a list of customer information including information on an electronic coupon of which use is declared by a customer, from the acquired plurality of pieces of customer information.

### APPENDIX 10

The customer information processing method according to Appendix 9, further including:

receiving a notice of a customer's use declaration of an electronic coupon; and

setting the information on the electronic coupon, included in the customer information of the customer which is stored in the customer information storage unit, the customer being the source of the notice, to a use declaration state on the basis of the notice of the use declaration.

### APPENDIX 11

The customer information processing method according to Appendix 10, further including:

imparting new identification information to an electronic coupon of which use is newly declared, the identification information being different from that of another electronic coupon of which use is already declared; and

setting the new identification information in the information on the electronic coupon.

### APPENDIX 12

The customer information processing method according to Appendix 10 or 11, further including:

receiving a notice of use reception of an electronic coupon;

setting the information on the electronic coupon, stored in the customer information storage unit, to a used state on the basis of the notice of the use reception; and

excluding the customer information having the information on the electronic coupon set to a used state from a list of objects to be preferentially displayed.

### APPENDIX 13

The customer information processing method according to any one of Appendixes 10 to 12, further including:

canceling the use declaration state indicated by the information on the electronic coupon which is stored in the customer information storage unit, in accordance with the duration of the use declaration state of the electronic coupon; and

excluding customer information in which the use declaration state indicated by the information on the electronic coupon is canceled, from a list of objects to be preferentially displayed.

### APPENDIX 14

The customer information processing method according to any one of Appendixes 9 to 13,

wherein the acquired plurality of pieces of customer information indicate a plurality of customers who are at least one of a type of customer predicted to be currently visiting a target store and a type of customer planning to visit the target store, or indicate the at least one type of customer and a customer who visited the target store in the past.

### APPENDIX 15

The customer information processing method according to any one of Appendixes 9 to 14, further comprising:

detecting a use reception operation for an electronic coupon of one customer selected from a list of a plurality of pieces of customer information displayed on the display unit; and

instructing execution of an adjustment process to which a discount corresponding to the electronic coupon is applied, using the information on the electronic coupon in accordance with the detected use reception operation.

### APPENDIX 16

A program causing at least one computer to execute the customer information processing method according to any one of Appendixes 9 to 15.

### APPENDIX 17

The program causing the computer to execute:

displaying information on an electronic coupon on a display unit;

receiving a use declaration operation for the electronic coupon displayed on the display unit; and

notifying another computer of use declaration of the electronic coupon in accordance with the received use declaration operation.

### APPENDIX 18

A computer-readable recording medium having the program according to Appendix 16 or 17 recorded thereon.

The application claims priority from Japanese Patent Application No. 2013-198197 filed on Sep. 25, 2013, the content of which is hereby incorporated by reference into this application.

What is claimed is:

1. A customer information processing device comprising:
an information acquisition unit that acquires a plurality of pieces of customer information indicating a plurality of customers from a customer information storage unit; and
a display processing unit that displays a list of the plurality of pieces of customer information acquired by the information acquisition unit on a display unit,
wherein the display processing unit preferentially displays a list of customer information including information on an electronic coupon of which use is declared by a customer, from the plurality of pieces of customer information acquired by the information acquisition unit.

2. The customer information processing device according to claim 1, further comprising:
a notice acquisition unit that receives a notice of a customer's use declaration of an electronic coupon; and
an information updating unit that sets the information on the electronic coupon included in the customer information of the customer which is stored in the customer information storage unit, the customer being the source of the notice, to a use declaration state on the basis of the notice of the use declaration.

3. The customer information processing device according to claim 2, further comprising:
an identification imparting unit that imparts new identification information to an electronic coupon of which use is newly declared, the identification information being different from that of another electronic coupon of which use is already declared,
wherein the information updating unit sets the new identification information in the information on the electronic coupon.

4. The customer information processing device according to claim 2,
wherein the notice acquisition unit further receives a notice of use reception of an electronic coupon,
wherein the information updating unit sets the information on the electronic coupon, stored in the customer information storage unit, to a used state on the basis of the notice of the use reception, and
wherein the display processing unit excludes customer information having the information on the electronic coupon set to a used state from a list of objects to be preferentially displayed.

5. The customer information processing device according to claim 2,
wherein the information updating unit cancels the use declaration state indicated by the information on the electronic coupon which is stored in the customer information storage unit, in accordance with the duration of the use declaration state of the electronic coupon, and
wherein the display processing unit excludes customer information in which the use declaration state indicated by the information on the electronic coupon is canceled, from a list of objects to be preferentially displayed.

6. The customer information processing device according to claim 1,
wherein the information acquisition unit acquires the plurality of pieces of customer information indicating a plurality of customers who are at least one of a type of customer predicted to be currently visiting a target store and a type of customer planning to visit the target store, or the plurality of pieces of customer information indicating the at least one type of customer and a customer who visited the target store in the past.

7. A portable information terminal capable of communicating with the customer information processing device according to claim 1, the portable information terminal comprising:
a display unit that displays information on an electronic coupon;
a reception unit that receives a use declaration operation for the electronic coupon displayed on the display unit; and
a notification unit that notifies the customer information processing device of use declaration of the electronic coupon in accordance with the use declaration operation received by the reception unit.

8. A store side processing terminal comprising:
a display unit;
a detection unit that detects a use reception operation for an electronic coupon of one customer selected from a list of a plurality of pieces of customer information displayed on the display unit;
a notification unit that notifies a customer information processing device of use reception of the electronic coupon in accordance with the use reception operation detected by the detection unit; and
an adjustment instructing unit that instructs execution of an adjustment process to which a discount corresponding to the electronic coupon is applied, using the information on the electronic coupon in accordance with the use reception operation detected by the detection unit.

9. A customer information processing method executed by at least one computer, the customer information processing method comprising:
acquiring a plurality of pieces of customer information indicating a plurality of customers from a customer information storage unit; and
displaying a list of the acquired plurality of pieces of customer information on a display unit,
wherein the displaying of the list of the customer information includes preferentially displaying a list of customer information including information on an electronic coupon of which use is declared by a customer, from the acquired plurality of pieces of customer information.

10. A non-transitory computer readable medium storing a program causing at least one computer to execute a customer information processing method, the customer information processing method comprising:
acquiring a plurality of pieces of customer information indicating a plurality of customers from a customer information storage unit; and
displaying a list of the acquired plurality of pieces of customer information on a display unit,
wherein the displaying of the list of the customer information includes preferentially displaying a list of customer information including information on an electronic coupon of which use is declared by a customer, from the acquired plurality of pieces of customer information.
